(19) United States
(12) Patent Application Publication
(10) Pub. No.: US 2009/0053363 A1
(43) Pub. Date: Feb. 26, 2009

(54) Method for Producing Soybean Paste Containing Pine Mushroom

(76) Inventor: Yeong Hwan An, Gangwon-do (KR)

Correspondence Address: CASELLA & HESPOS, 274 MADISON AVENUE, NEW YORK, NY, 10016, US

(21) Appl. No.: 12/224,352

(22) PCT Filed: Feb. 22, 2007
(86) PCT No.: PCT/KR2007/000922

§ 371 Date: Aug. 25, 2008

(30) Foreign Application Priority Data
Feb. 23, 2006 (KR) 10-2006-0017867

(51) Int. Cl. A23L 1/202

(52) U.S. Cl. 426/46

(57) ABSTRACT

The present invention relates to a method for producing a soybean paste containing pine mushrooms, which comprises processing pine mushrooms, mixing the processed pine mushrooms with fermented soybeans (meju), fermenting and maturating the meju mixed with the processed pine mushrooms, wherein the step of processing pine mushrooms comprises shattering raw pine mushrooms which are neither heated nor dried; boiling grains in water, maturating the boiled grains, drying the mature grains and pulverizing the dried grains to grain powder; and mixing the shattered pine mushrooms with the resulting grain powder, kneading the resulting mixture and drying the resulting dough. According to the present invention, we can produce a soybean paste containing pine mushrooms, which can maximize the unique tastes, flavors and nutritive elements of pine mushrooms and minimize the loss of nutritive elements in soybeans.

### TECHNICAL FIELD

The present invention relates to a method for producing a soybean paste containing pine mushrooms, and more particularly to a method for producing a soybean paste containing pine mushrooms, which comprises the steps of: processing pine mushrooms, mixing the processed pine mushrooms with fermented soybeans (meju), and fermenting and maturating the meju mixed with the processed pine mushrooms, wherein the step of processing pine mushrooms comprises shattering raw pine mushrooms which are neither heated nor dried; boiling grains in water, maturating the boiled grains, drying the mature grains and pulverizing the dried grains to grain powder; and mixing the shattered pine mushrooms with the resulting grain powder, kneading the resulting mixture and drying the resulting dough.

### BACKGROUND ART

It has been reported that pine mushrooms may help reduce blood cholesterol, improve blood circulation, prevent and control chronic diseases like coronary sclerosis, heart disease and diabetes mellitus, cure a hangover and do other medical actions. Therefore, pine mushrooms as food material have caught the attention recently due to their physiological function as a food material. Apart from their functionality, pine mushrooms also have unique tastes and flavors and they have been used as an ingredient for various foods. Now, researches have been continuing to develop appropriate recipes to improve the unique tastes, flavors and nutritional value of pine mushrooms.

Doenjang, soybean paste, has been a representative fermented food in Korea, and soybean is a main ingredient. Soybean is a high-protein ingredient. It contains saponin, isoflavones, ipiriflavone and other physiological beneficial substances, and it prevents cancer, osteoporosis and so on. Therefore, soybean products like soybean paste have been appreciated as a health food. It has been reported that significant amount of physiological beneficial substances in soybeans move into soy sauce or soybean paste during fermented soybeans (meju) being made. Therefore, researchers have been trying to find a way to maximize utility of physiological beneficial substances in soybeans for soybean products.

Conventionally, soybean paste can be generally made by putting meju in a jar, pouring brine over it, fermenting the whole mixture, maturating them, and separating solid parts from liquid parts. Solid parts are used as a soybean pastes and liquid parts are used as a soy sauce. While separating soybean paste from soy sauce, various soybean pastes can be made by putting subsidiary ingredients such as radishes, potatoes and pears, and various soy sauces can be made by putting subsidiary ingredients such as unripe red peppers, sesame leaves and soybean leaves. Consumers have recently showed their interest in tastes and flavors as well as their health and nutrition for foodstuffs, and researches have been proceeded to develop new soybean paste using various subsidiary ingredients like figs, green tea, apples, Phellinus linteus, and pine mushrooms which have not been used as an ingredient for traditional fermented foods.

For example of soybean paste containing pine mushrooms, Korean Patent Publication Number 10-2001-0027958 disclosed a method for producing a soybean paste containing pine mushrooms, which was made by boiling pine mushrooms, squeezing juice from the pine mushrooms and mixing the juice with other soybean paste ingredients, and Korean Patent Publication 10-2003-0032211 disclosed a method for producing a soybean paste containing pine mushrooms, which was made by steaming pine mushrooms at 90˜100° C. for 15 min, steaming the pine mushrooms at 60˜80° C. for 10 min, cooling the steamed pine mushrooms slowly, drying the cooled pine mushrooms slowly at a 20˜25° C. dryer for 12 hours and adding the dried pine mushrooms to a traditional soybean paste. Korean Patent Number 10-0469225 disclosed soybean paste which was made by mixing a first maturated soybean paste with about 10% of pine mushrooms cut into specific shaped pieces and second maturating for more than 6 months. Korean Patent Publication Number 10-2002-0064850 disclosed a functional fermented food and a method for producing it by culturing mycelia of a pine mushroom and adding the mycelia and the culture fluid to soy sauce, soybean paste and red pepper soybean paste.

However, boiling pine mushrooms and squeezing juice from the pine mushrooms, or steaming and drying pine mushrooms, or sun-drying pine mushrooms can cause significant loss of nutrients as well as unique tastes and flavors from pine mushrooms. The method by mixing meju with raw pine mushrooms without any pretreatment of pine mushrooms and maturating the resulting mixture had a problem that the juice from pine mushrooms could not mix with soybean paste well, and therefore, the resulting soybean paste became thinner.

Therefore, effective pretreatment methods for pine mushrooms have been required to retain the unique tastes and flavors of pine mushrooms and heighten the nutritional and physiological value of pine mushrooms for soybean paste containing pine mushrooms.

Also, conventional methods comprising the steps of putting meju in a jar, pouring brine over the meju, fermenting the resulting mixture, maturating the fermented mixture, separating solid parts from liquid parts and using only solid parts for making a soybean paste have a problem that the final soybean paste retains small nutrients and low product quality such as its taste. So, there is a need to produce a soybean paste having enough nutrients of soybeans.

### DISCLOSURE OF INVENTION

Technical Problem

To solve the problems of producing a soybean paste containing pine mushrooms, the present invention is directed to a method for processing pine mushrooms, which enables to keep the unique tastes, flavors and nutrients of pine mushrooms as intact as possible without heat treatment or dry treatment.

In addition, unlike conventional methods, the present invention is directed to a method for producing a soybean paste containing pine mushrooms, which is made by using both solid parts and liquid parts which are generated from producing process for a soybean paste without separating liquid parts from solid parts and enables to retain soybean nutrients as much as possible.

Technical Solution

To achieve the objectives of the present invention, the present invention provides a method for producing a soybean paste containing pine mushrooms comprising the steps of : processing pine mushrooms; mixing the processed pine mushrooms with fermented soybeans(meju); and fermenting and maturating the meju mixed with the processed pine mushrooms, wherein the step of processing pine mushrooms comprises: shattering raw pine mushrooms which are neither heated nor dried; boiling grains in water, maturating the boiled grains, drying the matured grains and pulverizing the dried grains to grain powder; and mixing the shattered pine mushrooms with the resulting grain powder, kneading the resulting mixture and drying the resulting dough.

The invention may be better understood by the descriptions and drawings attached hereto.

As shown in FIG. 1, the step of processing pine mushrooms comprises shattering raw pine mushrooms, which are neither heated nor dried; boiling grains in water, maturating the boiled grains, drying the matured grains and pulverizing the dried grains to grain powder; and mixing the shattered pine mushrooms with the resulting grain powder, kneading the resulting mixture and drying the resulting dough.

Pine mushrooms are harvested mainly in the fall, and small amounts can be harvested in June or July. Pine mushrooms are harvested, washed and shattered. The shattering means can be a pulverizer, a grinder, a crusher, a mixer, a mortar and so on. To produce a soybean paste containing pine mushrooms, boiling pine mushrooms and squeezing juice from the boiled pine mushrooms, or steaming pine mushrooms and drying the steamed pine mushrooms, or sun-drying pine mushrooms can cause significant loss of nutrients as well as unique tastes and flavors from pine mushrooms. The method by mixing meju with raw pine mushrooms without any pretreatment of pine mushrooms and maturating the resulting mixture had a problem that the juice from pine mushrooms could not mix with soybean paste well, and therefore, the resulting soybean paste became thinner. Also, drying pine mushrooms and shattering the dried pine mushrooms can cause significant loss of flavors from pine mushrooms. So, shattering raw pine mushrooms is preferable. However, mixing the shattered pine mushrooms with fermented soybeans can make the resulting soybean paste thin. Therefore, the step of boiling grains, maturating the boiled grains, drying the maturated grains and pulverizing the dried grains to grain powder is further necessary.

Grains for the processed pine mushrooms can be wheat, wheat flour, nonwaxy rice, waxy rice, barley and so on. Among them, barley can be matched up with pine mushrooms very well, and the description will be made hereinafter, laying stress on barley.

Barley can be harvested in early summer and hulled. Barley can be obtained before the pine mushrooms are procured, and therefore, there is a need to process barley separately. In other words, obtained barley are washed, cooked to boiled barley, and maturated for about 24 hours at the room temperature of 17˜25° C. After maturation, the boiled barley are brown, and the boiled barley are dried naturally, pulverized and kept till pine mushrooms are procured. ‘Maturation’ of barley means the process of the boiled barley being left within an open utensil for some time at the room temperature to become a little bit spoiled.

Then, the barley powder and the shattered pine mushrooms are mixed with the ratio of 1:1 by weight, and kneaded. Then, the resulting dough becomes bumpy. The resulting dough is dried naturally. Drying the resulting dough fast on sunny days for 2˜3 days is preferable. It would be better that the dried, processed pine mushrooms are kept well until the next spring.

Then, the step of preparing for fermented soybeans (meju) is as follows as shown in FIG. 2.

A traditional meju is made by soaking washed soybeans in water for about one day, steaming or boiling the soybeans in water, mashing the cooked soybeans and shaping it into a block, drying the block naturally for about 30˜35 days, fermenting the dried block with straws at 27˜40° C. for about 20 days when the dried meju cracks, and pulverizing it.

An improved meju is made by soaking washed soybeans in water for about one day, steaming or boiling the soybeans in water, mixing the cooked soybeans with koji molds, fermenting the mixture for 2˜3 days, sun-drying the fermented mixture for 7˜10 days if white, thick gum-like substances form, and pulverizing it.

It is possible to use a traditional meju only or an improved meju only, but then a soybean paste of unique full body cannot be obtained. Therefore, to mix a traditional meju with an improved meju is preferable for a soybean paste of better taste and higher nutritive value. Especially, it is more preferable that the ratio of a traditional meju to an improved meju is 4:1 by weight.

Finally, as shown in FIG. 3, on March of the next year according to the lunar calendar, the processed pine mushrooms and the mixed meju powder are put together in a jar and an appropriate amount of brine are poured into the jar. Then the step of fermenting and maturating the resulting whole mixture are proceeded. While conventional soybean pastes are made by separating solid parts from liquid parts at the step of fermenting and maturating the meju, and shattering the solid parts, and conventional soy sauce can be obtained from the liquid parts by sterilizing, a soybean paste in the present invention are made by using both solid parts and liquid parts. Soybean paste using solid parts only may lose significant amount of effective substances in soybeans, because significant parts of meju may move into soy sauce, and it may make a soybean paste of worse taste, small nutrients and lower quality.

It is preferable that the ratio of the meju to the processed pine mushrooms is 95:5 by weight. The processed pine mushrooms beyond the ratio may increase the unit cost of production, give a soybean paste an unpleasant feeling due to pine mushrooms' bitter taste and flavor. The processed pine mushrooms below the ratio may not give a soybean paste the unique tastes and flavors of pine mushrooms.

At the step of mixing the meju with the processed pine mushrooms, starch syrup, red pepper powder and so on can be mixed according to one's preference. Starch syrup can help to control salty taste of soybean paste and look good. Red pepper powder can add sharp taste to a soybean paste.

Fermenting and maturating the meju with the processed pine mushrooms takes about 6˜10 months.

### ADVANTAGEOUS EFFECTS

According to the present invention of a soybean paste containing pine mushrooms, it is possible to retain the unique tastes, flavors and nutrients of pine mushrooms in a soybean paste and to intake more soybean nutrients from a soybean paste in the present invention than from a soybean paste in the conventional soybean pastes. Therefore, the present invention allows for producing an excellent soybean paste which enables to satisfy customers' expectations for higher quality of tastes and flavors as well as their nutritional demand.

### DESCRIPTION OF DRAWINGS

FIG. 1 is a block diagram showing the step of processing pine mushrooms.

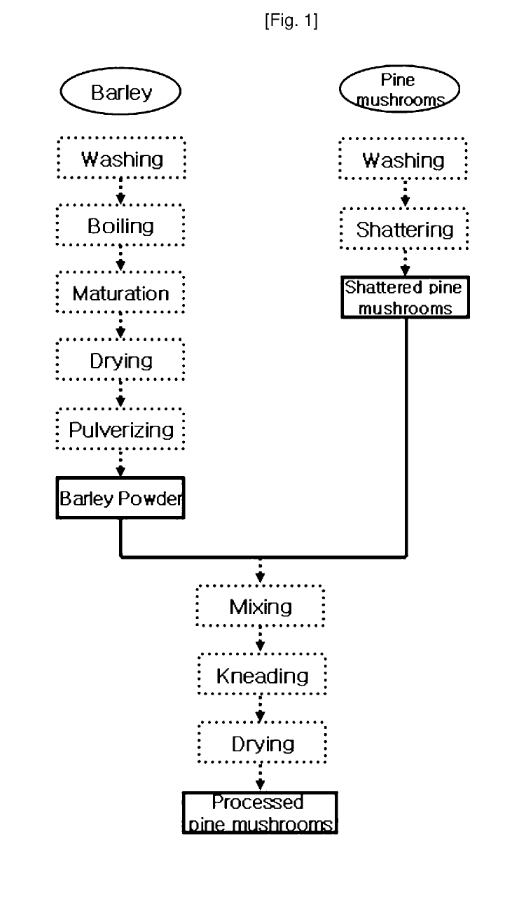

FIG. 2 is a block diagram showing how to prepare fermented soybeans (meju).

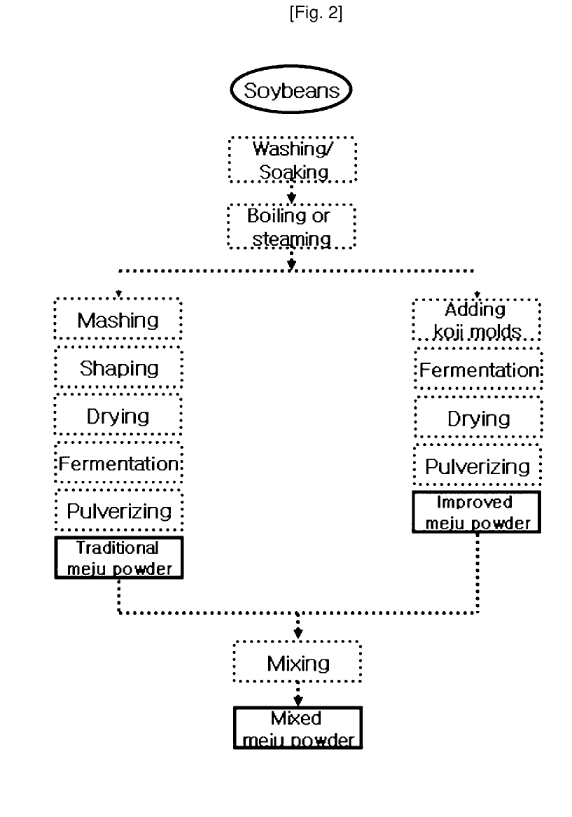

FIG. 3 is a block diagram showing the step of fermenting and maturating the meju mixed with the processed pine mushrooms.

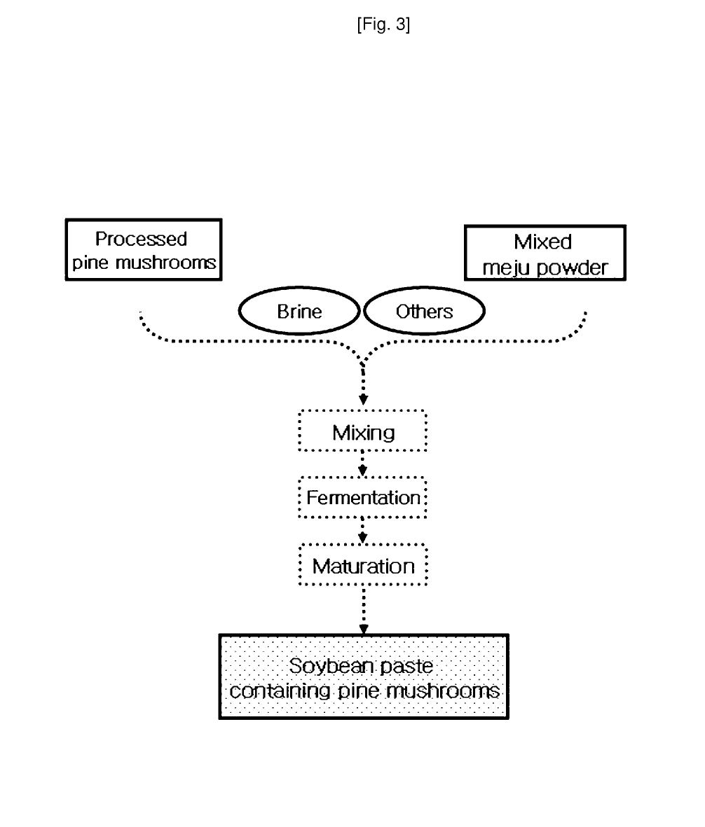

### DETAILED DESCRIPTION OF THE PREFERRED EMBODIMENTS

A detailed description of preferred embodiments of the present invention is provided below and it will be evident that the present invention cannot be defined only by the described embodiments herein, and it will be understood that the invention herein described are generally applicable and executed as various modified embodiments by those skilled in the art.

Around May, barley was obtained, washed and boiled in water and left at 17˜25° C. for 24 hours. Then, the brown cooked barley was dried by sunlight, and pulverized to barley powder.

Around June or July, pine mushrooms were obtained, washed and shattered using a mixer or a mortar. Then, the barley powder and the shattered pine mushrooms were mixed with the ratio of 1:1 by weight and kneaded. As a result, bumpy mixture was obtained and dried for 48 hours on sunny days to get processed pine mushrooms. The processed pine mushrooms were kept until the next spring.

Around November or December, soybeans were purchased, washed and made into a meju. To make a traditional meju, soybeans were soaked in water for 10 hours, steamed enough to become soft, mashed in a mortar, shaped into a block, and dried naturally for 30 days under circumstances with the smell of soil. Then, the dried soybean block was put with straws in a ferment room of 27˜40° C. and 70˜80% humidity for 20 days for fermentation, and then pulverized to powder.

To make an improved meju, soybeans were soaked in water for 10 hours, steamed enough to become soft, mixed with koji molds and fermented for 48 hours. When white, thick gum-like substances formed, the fermented mixture was dried under the sun for 7 days, and then pulverized to powder.

Around January of the next year, the traditional meju powder and the improved meju powder were mixed with the ratio of 4:1 by weight in order to get a mixed meju powder. The mixed meju powder and the processed pine mushrooms were mixed with the ratio of 95:5 by weight. Per 18 l soybeans, 3 kg starch syrup and 200 g red pepper powder were added to the mixture of the mixed meju powder and the processed pine mushrooms. Then, brine of 1.2 kg salt and 8 kg water was added into the resulting whole mixture 20 kg of the mixed meju powder, the processed pine mushrooms, starch syrup and red pepper powder to make a paste. After 6 months of fermentation and maturation, a soybean paste containing pine mushrooms was completed.

### INDUSTRIAL APPLICABILITY

According to the present invention, in comparison with conventional soybean pastes containing pine mushrooms, it is possible to maximize the unique tastes, flavors and nutritive elements of pine mushrooms and retain more nutritive elements of soybeans. Therefore, we can produce a high quality soybean paste containing pine mushrooms, and it has an excellent industrial applicability.

1. A method for producing a soybean paste containing pine mushrooms comprising the steps of: processing pine mushrooms; mixing the processed pine mushrooms with fermented soybeans(meju); and fermenting and maturating the meju mixed with the processed pine mushrooms,
wherein the step of processing pine mushrooms comprises:
shattering raw pine mushrooms which are neither heated nor dried;
boiling grains in water, maturating the boiled grains, drying the mature grains and pulverizing the dried grains to grain powder; and
mixing the shattered pine mushrooms with the resulting grain powder, kneading the resulting mixture and drying the resulting dough.

2. The method of claim 1,
wherein the grain is barley, and the shattered pine mushrooms and the grain powder are mixed with the ratio of 1:1 by weight in the processed pine mushrooms.

3. The method of claim 2,
wherein the meju is the mixture of a traditional meju and an improved meju.

4. The method of claim 3,
wherein the traditional meju and the improved meju are mixed with the ratio of 4:1 by weight.

5. The method of claim 3,
wherein the meju and the processed pine mushrooms are mixed with the ratio of 95:5 by weight.

6. The method of claim 5,
wherein the step of fermenting and maturating the meju mixed with the processed pine mushrooms is characterized by fermenting and maturating the whole mixture, not pouring out liquid generated during the process of fermenting and maturating the meju with the processed pine mushrooms in brine.
